(19) United States
(12) Patent Application Publication
(10) Pub. No.: US 2026/0208502 A1
(43) Pub. Date: Jul. 23, 2026

(54) DEVICE AND METHOD FOR DRYING PRINTED SUBSTRATES IN A PRINTING MACHINE

(71) Applicant: MGI Digital Technology, Fresnes (FR)

(72) Inventors: Louis Gautier Le Boulch, Groix (FR); Edmond Abergel, Paris (FR)

(21) Appl. No.: 19/142,287

(22) PCT Filed: Dec. 14, 2023
(86) PCT No.: PCT/EP2023/085882

§ 371 Date: Jun. 23, 2025

(30) Foreign Application Priority Data
Dec. 21, 2022 (FR) FR2214161

(51) Int. Cl. B41J 11/00; F26B 15/10

(52) U.S. Cl. CPC B41J 11/00212; B41J 11/00218; B41J 11/007; F26B 15/10

(57) ABSTRACT

In the field of printing, in particular in the field of digital printing of inks/varnishes, a device and a method for drying the inks/varnishes of the printed substrates in a printing machine comprising at least one substrate printing station followed by a station for drying the printed substrate as well as a station for transporting the substrate through the printing and drying stations.

### FIELD AND BACKGROUND OF THE INVENTION

The present invention relates to the field of printing, in particular to the field of digital printing of inks/varnishes, and, more particularly, to a device and a method for drying the inks/varnishes of printed substrates in a printing machine comprising at least one substrate printing station followed by a station for drying the printed substrate as well as a station for transporting the substrate through said printing and drying stations.

### INTRODUCTION

Substrate transport, and in particular the drying of printed inks/varnishes on the substrates during their transport using automated or industrially manufactured processing, is a particular technical challenge. As printing rates and, therefore, the associated transport speed of the substrates become increasingly important to meet production/marketing requirements, all printing machine stations must be continuously improved.

By way of illustration, optimized and efficient drying is a major challenge during this process. Drying may include an infrared (IR) and/or near-infrared (NIR) and/or heated airflow drying oven and/or drying with an ultraviolet (UV) lamp and/or a UV light-emitting diode (LED) and/or a photonic process.

The present invention particularly relates to an infrared (IR) and/or near-infrared (NIR) and/or ultraviolet (UV) drying station, which is generally positioned above the printed substrate so as to cover its entire width or its entire usable width, as defined below, and is located near the printing station; this drying station thus typically includes several drying lamps (for instance, infrared) that remain lit during a print job in order to prevent damage caused by frequent switching on and off. The usable width is defined as the minimum width of the portion of the printed substrate that requires drying.

Although there are already drying stations whose drying efficiency can be adjusted depending on the desired drying effect, the Applicant encountered numerous problems when implementing them in the printing machines described below. Examples include problems with premature aging of all parts related to substrate transport and located near the drying station, leading to potential inaccuracies not only at the transport station, but also in the processing stations located downstream and/or upstream of the drying station; problems related to premature aging of the printing stations, particularly the print heads located near the drying station, leading to print nozzle blockages and corresponding printing inaccuracies; as well as problems with drying uniformity across the printed areas of the substrate.

Drying station manufacturers have also developed their equipment to better control energy dissipation phenomena, for example by developing air channeling and/or blowing devices within the drying station. However, there is still a need that the Applicant has set out to resolve in the present invention.

### SUMMARY OF THE INVENTION

### Invention—Device

To this end, the invention relates to a substrate printing device comprising at least one station for ink/varnish printing, followed by a station for drying the printed substrate without contact with the printed substrate, as well as a station for transporting the substrate through said printing and drying stations, in which
the three printing, drying, and transport stations are controlled by at least one control station;
the drying station comprises infrared (IR) and/or near-infrared (NIR) and/or ultraviolet (UV) drying means, a control station, and a movable opening/closing means controlled by the control station of the drying station, said movable opening/closing means being positioned between the drying means and the printed substrate.

The substrate is preferably transported in the printing machine in a flat, horizontal position. An essential feature of the present invention is that it makes it possible to subject to drying radiation (for example infrared radiation) only the longitudinal portions of the substrate and/or transverse portions of the substrate which must be dried, namely those onto which the ink and/or varnish has just been sprayed, while avoiding subjecting the other portions of the substrate or nearby equipment to these same radiations. In the specification and the claims which follow, the longitudinal direction corresponds to the direction of the forward motion of the substrate in the plane of the substrate transport path and the transverse direction corresponds to the direction perpendicular to the forward motion of the substrate in the plane of the substrate transport path. Any type of substrate transport may advantageously be used within the framework of the present invention. By way of illustration, mention may be made of sheet-fed transport in which the substrate is generally stationary on a support which is transported/moved through the printing and drying stations, or reel-to-reel transport in which it is the substrate itself which is transported/moved through the printing and drying stations and which, therefore, plays its role as support, knowing that the advantages provided by the invention are greater in sheet-fed transport due to the inherent distance separating each printed substrate. In the remainder of the specification and the claims that follow, the useful surface area of the substrate is defined as the printed portion(s) of the printed substrate, said portion itself preferably being defined as the smallest rectangle surrounding said printed portion(s).

### Invention—Method

The invention also relates to a printing, transporting, and drying method implemented by the substrate printing device according to the invention, in which the control station of the drying station receives instructions from the transport station and/or the printing station to control the opening of the movable opening/closing means as the substrate passes through the useful surface and to control the closing of the movable opening/closing means after the substrate has passed through the useful surface.

### BRIEF DESCRIPTION OF DRAWINGS

The invention, with its features and advantages, will become more apparent upon reading the description provided with reference to the accompanying drawings, in which:

FIGS. 1 to 4 schematically illustrate several aspects and several embodiments of the invention, by way of example.

FIG. 1 shows a device according to the invention, comprising an infrared cassette and a rotating conveyor belt.

FIG. 2 shows examples for the conveyor belt.

FIG. 3 shows the substrate feed and the progress of the belt for a belt whose cutout surface corresponds to that of the cassette.

FIG. 4 shows the conveyor belt feed for a conveyor belt whose sealing surface corresponds to that of the cassette.

### DETAILED DESCRIPTION OF THE INVENTION

The present invention offers numerous advantages over prior art techniques. The advantages provided by the present invention will be further highlighted in the detailed description of the figures.

A first illustration of the present invention relates to sheet-fed transport due to the inherent distance separating each printed sheet, as explained above. Indeed, in this illustration, the control station of the drying station may be able to control the movable opening/closing means between each printed sheet pass. For example, the control station of the drying station may be able to synchronize the closing/opening of the movable opening/closing means depending on the presence or absence of the printed sheet to be dried, based on the information regarding the distance between each substrate (for example, of approximately a few centimeters; for example, between 3 and 50 cm) and the substrate transport speed that it receives from the transport station.

A second illustration of the present invention relates to sheet-fed transport when the longitudinal dimension of the useful surface area of the printed sheet is less than the dimension of the sheet itself. For example, the control station of the drying station may be able to synchronize the closing/opening of the movable opening/closing means not only based on the presence or absence of the printed sheet to be dried, according to the distance information between each substrate and the substrate transport speed that it receives that it receives from the transport station, but also based on the information on print positioning on the sheet that it receives from the printing station.

This second illustration may also advantageously relate to the reel-to-reel illustration of the present invention because the use of the present invention in the reel-to-reel application may depend on the longitudinal distance separating each useful surface of the reel. Indeed, in the event that a print to be dried is carried out over the entire length of the reel, this second illustration is of no use because the drying may also have to operate continuously. However, and this is what most often characterizes reel-to-reel applications, the image printed in reel-to-reel processes is generally repeated at regular intervals, which justifies the advantageous use of the invention; thus, the control station of the drying station may be able to synchronize the closing/opening of the movable opening/closing means not only based on the roll transport speed that it receives from the transport station, but also based on the information on print positioning on the sheet that it receives from the printing station.

A third illustration of the present invention relates to sheet-fed and/or reel-to-reel applications, when the transverse dimension of the useful surface is less than the width of the roll and/or the sheet. For example, in sheet-fed printing, the control station of the drying station may synchronize the closing/opening of the movable opening/closing means not only based on the presence or absence of the printed sheet to be dried, according to the information on the distance between each substrate and the substrate transport speed that it receives from the transport station, but also based on the information on print positioning on the sheet that it receives from the printing station. For example, in reel-to-reel printing, the control station of the drying station may synchronize the closing/opening of the movable opening/closing means not only based on the transport speed of the roll that it receives from the transport station, but also based on the information on print positioning on the sheet that it receives from the printing station.

It will also be understood from the foregoing that a fourth illustration may advantageously correspond to the combination of the second and third illustrations mentioned above.

In a particular embodiment according to the present invention, the transport speed of the substrate is between 10 and 300 meters per minute.

Drying station

The drying station according to the present invention follows the printing station along the substrate transport station in the claimed printing device. Generally, the distance between the printing station and the drying station along the transport station is between 300 mm and 2000 mm. Therefore, the drying station according to the present invention comprises infrared (IR) and/or near-infrared (NIR) and/or ultraviolet (UV) drying means, a control station, and a movable opening/closing means controlled by the control station of the drying station, said movable opening/closing means being positioned between the drying means and the printed substrate; the drying station according to a preferred embodiment of the present invention comprises an infrared drying means.

The dimensions of the drying means facing the transported printed substrate are generally selected to allow efficient drying of the inks/varnishes that may be located across the entire width (or transverse dimension) of the substrate. A transverse dimension (i.e., perpendicular to the longitudinal axis in the plane of the substrate transport path) that is at least equivalent to the transverse size of the largest substrate used may be cited for illustrative purposes; as for the longitudinal dimension (in the direction of the substrate forward motion), it is generally determined during the design of the printing machine, after determining all influencing factors. Examples of influencing factors that may be cited for illustrative purposes include the dimensions and types of substrates that may be processed in the printing machine, and/or the types and quantities of inks/varnishes that may be printed on said substrates, and/or the size of the infrared (IR) and/or near-infrared (NIR) and/or ultraviolet (UV) drying lamps and their power. A transverse dimension ranging from 300 mm to 2000 mm may be cited for illustrative purposes. A longitudinal dimension ranging from 300 mm to 2000 mm may also be cited for illustrative purposes.

Regarding the dimensions of the drying station, these obviously depend on the sizing of its components, for example, the drying means and the one or more movable opening/closing means as well as, optionally, the cooling means described below.

The distance between the printed substrate and the drying station may be adjustable, in some cases, in order to accommodate substrates of varying thicknesses. Generally, a distance of a few millimeters (for example, between 2 and 20 mm) is preferred in order to concentrate the effects of irradiation on the printed substrate and limit irradiation of the surrounding environment.

The power range of the heating means should preferably be adapted to the quantity of ink/varnish deposited per unit area to be dried, the content and type of solvent in the inks/varnishes used as well as the substrate transport speed. For illustrative purposes, a power range of 1 to 100 kW per square meter, for example, 10 to 50 kW per square meter, may be cited. Since these values are particularly suitable for running speeds of 1 m/s, ranges of power values per square meter multiplied by the running speed of the substrate under the heating means, ranging from 1 to 100 kW per square meter per second, for example, 10 to 50 kW per square meter per second, may also be illustrated.

Thus, in a particular embodiment, the present invention relates to a substrate printing device and/or a corresponding implementation method in which the power of the heating means is controlled based on the quantity of ink/varnish deposited per unit area to be dried, and/or the content and type of solvent contained in the ink/varnish, and/or the transport speed of the substrate through the drying station; these three criteria are preferably taken into account in the control of the heating means.

### Movable Opening/Closing Means

Any movable opening/closing means positioned between the drying means and the printed substrate may advantageously be selected in the present invention. Mention may be made, by way of illustration, of a system of closable sliding grilles (such as ventilation or water drainage grilles), adjustable slats (like slatted shutters), etc.

Optionally, the movable opening/closing means is fully mobile.

Optionally, the movable opening/closing means is a flat, flexible surface that rotates around the heating means.

Optionally, the movable opening/closing means is a rotating conveyor belt having at least one cutout surface, preferably adapted to the surface of the heating means.

Optionally, the opening/closing of the movable opening/closing means is controlled by the control station of the drying station based on information transmitted by the printing station and/or the transport station.

Optionally, this information is the substrate transport speed through the drying station and/or the distance between each substrate portion and/or between each substrate to be dried.

Optionally, the control station of the drying station controls the rotational speed of a rotating conveyor belt.

Preferably, the maximum opening and closing dimensions are greater than or coincide with the transverse and longitudinal dimensions of the heating means; preferably, these dimensions are greater than or coincide with the entire irradiation surface of the heating means. In a particular embodiment according to the present invention, the opening dimensions coincide with the dimensions of the useful surface of the printed substrate(s).

The emitters of the heating means are generally in the form of tubes with or without an integrated reflector and with a diameter close to one centimeter, for example, a diameter between 0.5 and 3 cm; for reasons related to their thermal regulation, these tubes are generally spaced apart by an equivalent distance, for example, a distance between 0.5 and 3 cm.

Although closable sliding grilles already address some of the challenges mentioned above, their use is not preferred in the context of the present invention because the opening surface of this type of grille (one side of which is fixed) represents only a portion of the irradiation surface of the heating means, which drastically reduces the advantages and, therefore, the interest in their use. Indeed, this feature implies that the printed substrate only receives a portion of the irradiation from the heating elements, resulting in a loss of efficiency. The same applies to adjustable slats, which, although more advantageous than grilles, have the same partial opening feature due to their fixed edges.

Furthermore, the production of these movable opening/closing means, consisting of closable sliding grilles or adjustable slats, is complex when it comes to producing dryers with high energy density (for example, 30 kW per m²) due to the high temperatures (up to 1000° C., or even more) to which they are subjected, which cause significant expansion and aging phenomena.

In a particular embodiment, the movable opening/closing means, unlike the aforementioned grilles and/or slats, is fully mobile, which, as explained below in the description, provides an additional advantage in terms of energy dissipation control. As an illustrative example of a mobile movable opening/closing means, at least one mobile element may be used to block the heating means when there is no useful substrate surface area to be dried and to allow the necessary opening for the drying means when there is a useful substrate surface area to be dried.

In one embodiment, the one or more mobile movable opening/closing means is a flat surface; for example, a flat, flexible surface that rotates around the heating means.

This rotation around the heating means may preferably be carried out in the same direction and in the same orientation as that of the substrate transport when the mobile element moves between the heating means and the substrate.

In a particular embodiment of the present invention, the control station of the drying station comprises means for controlling the speed of the mobile movable opening/closing means based on the substrate transport speed that is transmitted to it by the transport station. For illustrative purposes, the transport speed of the mobile movable opening/closing means may be between 1 and 400 meters per minute when in motion, although it may also remain stationary for very short periods of time to ensure the synchronization objectives described below.

The following description is provided in relation to an example embodiment of a mobile movable opening/closing means of the conveyor belt type, and more particularly, of the rotating conveyor belt type, but it is understood that other mobile elements as suitable as a conveyor belt may also be used within the scope of the present invention.

As an illustration of a mobile movable opening/closing means, the conveyor belt rotating around the heating means may have at least one cutout surface. For illustrative purposes, the cutout surface of the conveyor belt is shaped as a rectangle and has a transverse dimension corresponding, for example, to that of the heating means; for illustrative purposes, the shape and dimensions of the cutout of the rotating conveyor belt correspond to those of the entire irradiation surface of the heating means; examples of this type of conveyor belt will be described using the appended figures detailed below.

The use of several (for example, two or three) mobile movable opening/closing means (for example, conveyor belts, (partially) superimposed or not) is also possible, although it may require additional adjustments in order to achieve the desired effects, namely the generation of a surface that is sometimes sealing and sometimes open during the implementation of the claimed device.

In a particular embodiment, the drying station also includes a temperature control mechanism for the movable opening/closing system, as, as mentioned above, temperatures within the drying station can reach 1000° C. or even more.

In a particular embodiment, the drying station also includes means for controlling the temperature of the movable opening/closing means as, as mentioned above, temperatures within the drying station can reach 1000° C. or even more. To this end, any cooling device may advantageously be used within the scope of the present invention; as an example, one or more fans may be cited. An additional advantage associated with the selection of a mobile movable opening/closing means is that the movement generated by its mobility may contribute to the dissipation of energy; in addition, a cooling device may advantageously be positioned outside the areas located between the heating means and the substrate.

Conveyor belt

In a particular embodiment, when the mobile movable opening/closing means is a conveyor belt, which may be a rotating conveyor belt, it is advantageously composed of one or more layers of woven or non-woven textile materials that preferably have low thermal conductivity and are resistant to high temperatures (for instance, several hundred degrees Celsius or more than a thousand or two thousand degrees Celsius).

For illustrative purposes, high-temperature textile materials are understood to mean having a melting point above 750° C., 1000° C., 1250° C., 1500° C., and even 1750° C.

For illustrative purposes, textile materials with low thermal conductivity are understood to mean having values below 0.5 (measured in W/m° C. at a temperature of 500° C.), for example, below 0.35, or even below 0.2. This thermal conductivity may be measured using any appropriate method. An illustrative example is the method performed in accordance with ASTM C-177-76 (Steady State Heat Transmission Properties measured by means of the Guarded Hot Plate).

The thickness of the conveyor belt may preferably be between 0.1 and 2 mm. This thickness may be measured by any suitable method. An illustrative example is ASTM D1777 Option 1.

Textile materials based on aramid, fiberglass, carbon, graphite, silica, and/or vermiculite may be cited for illustrative purposes.

The textile materials used are preferably woven textile materials made of continuous filament ceramic fibers. These are preferably metal oxide fibers, which can be easily converted into textiles. The characteristics of these metal oxide fibers may advantageously be selected from one or more of the following: metal oxide refractory fibers such as aluminum oxide, silicon oxide, and/or boron oxide, and/or a mixture of two or more of said metal oxides; refractory fibers of a mixture of Al₂O₃/SiO₂/B₂O₃ metal oxide; fibers with a diameter between 5 and 20 microns.

Optionally, at least one side of the conveyor belt may be advantageously aluminized to reflect part of the received energy, preferably only the inner side of the conveyor belt (the one facing the heating means).

Optionally, the conveyor belt may include stiffeners (for instance, transversely placed slats), preferably made of materials also having low thermal conductivity.

The moving conveyor belt may be driven by any suitable drive system; a system comprising two parallel chains or belts along which it is fastened directly or via tensioners (for instance, springs) may be cited for illustrative purposes.

### Printing

The present invention may prove beneficial for drying any type of printing performed with inks and/or varnishes, whether with or without a printing plate. The present invention is particularly suitable for digital printing according to the present invention; this printing form-free technique uses computer data from a control computer to the printing machine. Any type of digital printing may advantageously be used within the scope of the present invention. For example, this digital printing may advantageously be selected from processes such as inkjet (continuous or on-demand), electrophotography or xerography, magnetography, ionography, elcography, and thermography. Inkjet, however, is the preferred printing technique in the present invention because accidental drying of ink in the nozzles of inkjet print heads represents an additional critical problem for this technology, a problem which has been advantageously solved by the present invention.

### Substrate

The present invention may prove beneficial for drying any type of printed substrate; examples include substrates of varying nature (paper, plastic, organic or inorganic, etc.), and/or varying thicknesses, and/or varying dimensions (for example, and without limitation, for sheet-fed application of a format whose sides are approximately one centimeter, for example, an A10-type format, or, more specifically, a credit card-type format; up to a format whose sides are on the order of several meters, for example, an A0-type format or a 2×2 meter format).

### Support

As already explained above, any type of support may advantageously be used within the scope of the present invention, bearing in mind that in the case of reel-to-reel transport, it is generally the substrate itself that serves as the support; this could also be the case for sheet-fed transport when the transport system consists of means for gripping and moving the substrates, for example, grippers arranged on rails or rotating chains.

In a particular embodiment, the support has at least a dual function, namely that of transporting the substrate and that of holding the substrate in a stationary position relative to the substrate during its transport. An example of a system for holding the substrate in a stationary position (for example, flat) on the support, may be means for gripping or pressing the substrate, for example, grippers and/or pinching strips. As an illustrative example, a belt, such as a rotating conveyor belt, or more specifically, a vacuum rotating conveyor belt may be cited; a vacuum rotating conveyor belt may advantageously be perforated with numerous holes, allowing it to generate suction and thus secure the substrate onto the belt during transport through the suction force. This rotating conveyor belt will advantageously be made of materials such as those defined above for the conveyor belt of the movable opening/closing means.

In a particularly preferred embodiment according to the present invention, the substrate transport device in the printing machine comprises carriages that move through the printing and drying stations, for example by means of a motorization system for moving said carriages on a fixed rail along a transport path; these carriages, which hold the substrates in a stationary position (for instance, stationary and flat), preferably comprise a table (preferably a vacuum table) for holding the substrate in a stationary position relative to the table (for instance, stationary and flat), along the transport path during printing and drying of the substrate (and, optionally, during any preliminary, intermediate, or subsequent treatment of the substrate). Vacuum tables and their operation are well known to a person skilled in the art, and the latter will, therefore, be able to easily use a vacuum table suitable for the present invention. The construction and dimensions of the vacuum table are not critical as long as it fulfills its role of holding the substrate in a stationary position (for instance, flat). Thus, according to a particular embodiment of the present invention, the force holding said substrate in a stationary position on the vacuum table will be greater than any other force which could cause the substrate to move during the treatments of said substrate and/or during the movements of the carriage.

The upper part of vacuum tables is generally called the vacuum plate which is perforated with numerous holes allowing the table to exert suction and, therefore, to hold the substrate on the plate thanks to this suction force. This plate is usually primarily made of metal (such as aluminum), steel, and/or any plastic material, and/or polytetrafluoroethylene (also known as Teflon), and/or other suitable composite or ceramic materials. In an alternative embodiment of the present invention, another type of vacuum table is used, namely a vacuum table comprising a honeycomb structural layer. This honeycomb structural layer not only allows the surface temperature to be homogenized but also better dissipates said temperature throughout the table, which, in combination with the drying station according to the present invention, provides a synergy of advantages when implemented. This honeycomb structural layer has several additional functions/advantages, including, by way of illustration and without limitation,
a sufficiently flat upper surface to hold the substrate in position,
allowing air to pass through to ensure a negative pressure behind the substrate and, therefore, optimal support in the vacuum table option,
limiting the effects of thermal conduction with the substrate due to its small contact surface,
limiting the effects of thermal conduction with the lower and upper layers of the table (which has proven particularly relevant for certain processing stations, for example, the infrared drying station),
helping to eliminate vibration problems encountered with prior art transport devices,
thus improving the transport of printable and printed substrates across all processing stations included in a printing machine, particularly a printing machine without substrate contact, such as inkjet printing machines.

By way of illustration and non-limiting example, the honeycomb structural layer has a thickness of between 1 and 100 mm, for example between 5 and 30 mm, preferably between 5 and 15 mm, for example 8 mm; the size of the cells (for instance, alveoli) is between 10 microns and 10 mm, for example between 1 and 8 mm, preferably between 2 and 5 mm, for example 3.6 mm; the thickness of the cell walls (for instance, alveoli) is between 0.5 microns and 5 mm, for example between 10 and 200 microns, preferably between 30 and 100 microns, for example 50 μm.

By way of illustration and non-limiting example, the honeycomb structural layer features a regular hexagonal tiling; therefore, it is composed of straight prisms with a hexagonal base (which, therefore, preferably do not have holes in their vertical walls).

The surface dimensions of the honeycomb structural layer may be selected based on needs and applications and may preferably correspond at least to the surface area of the substrate (or substrates if several are held on the same table); dimensions (1/L) of approximately 760/1070 millimeters may be cited as an illustrative example. The widths/lengths of this honeycomb structural layer (for example, a rectangular parallelepiped frame with a height corresponding to the aforementioned thickness “t”) will preferably coincide with those of the lower suction layer.

In a particular embodiment of the present invention, the honeycomb structural layer is removably fastened to the table, allowing it to be replaced and/or changed depending, for example, on the types of substrates used. Any movable fastening system may advantageously be used; as an illustrative example, a toggle latch fastening and/or a snap-fit-type fastening may be cited.

According to an alternative embodiment of the present invention, the honeycomb structural layer is made of aluminum; it is obvious that a person skilled in the art will know how to select other materials, similar or not to aluminum, which will also meet the requirements of the present invention, for example steel and/or any suitable plastic and/or composite and/or ceramic material.

### MESH

In a particular embodiment of the present invention, the plate or table (such as the vacuum table) includes a structural overlay consisting of a substrate-holding mesh, which is resistant to high temperatures. By way of illustration and not limitation, this mesh may advantageously be used for low-grammage substrates, thereby avoiding any potential “marking” of said substrates when they are immobilized on the table. In fact, without wishing to be limited by this explanation, the Applicant believes that the use of a substrate-holding mesh of this type will also prevent premature aging of the plate or holding table while ensuring and improving the uniformity of the suction.

By way of illustration and not limitation, a ceramic fiber grille may advantageously be used as the mesh; said mesh may advantageously be made of materials such as those defined above for the conveyor belt of the movable opening/closing means. An additional feature of this mesh/conveyor belt may be to ensure proper suction of the vacuum elements for substrate retention; thus, the air permeability of said mesh/conveyor belt may be sufficient to enable this retention; an air permeability (in (cm³/cm²/sec)@125 Pa) greater than 10, for example, greater than 25, may be cited for illustrative purposes.

By way of illustration and not limitation, the mesh size may be selected from fine meshes to avoid texturizing the printed paper.

### Inks/Varnishes

Any type of material requiring drying by a drying station as defined above may advantageously benefit from it. As previously explained, the invention is particularly well-suited for inks/varnishes printed on substrates.

In a particular embodiment, the inks/varnishes are solvent-based and/or water-based; with preferably a solvent and water content greater than 15% by weight of the ink, greater than 30% by weight of the ink, or even greater than 45% by weight of the ink, or even greater than 80% by weight of the ink (weight of the solvent and water divided by the weight of the ink).

### Figures

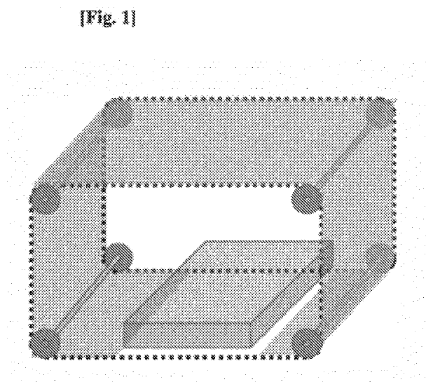

FIGS. 1 to 4 schematically illustrate an overview of the drying means and a movable opening/closing means according to the present invention. They show an infrared cassette as the drying means (represented by the rectangular parallelepiped and advantageously comprising lamps and reflectors), around which a rotating conveyor belt rotates; they also show a rectangular cutout of the conveyor belt whose transverse dimension corresponds to the transverse dimension of the irradiation surface of the heating means (in this case, the length of the infrared cassette), while its longitudinal dimension corresponds to or is greater than the longitudinal dimension of the irradiation surface of the heating means (in this case, the width of the infrared cassette).

Thus, when the printed substrate to be dried passes under the cassette, the control station of the drying station will control in the most appropriate manner not only the power/temperature emitted by the drying means (for instance, the infrared lamps), but also the positioning and rotational speed of the conveyor belt based on the information received by said control station, information such as the position of the substrate (or the useful surface area of the substrate) to be dried in the printing machine, its transport speed, and the length of the area to be dried (in the direction of the substrate forward motion). This information will not only define the passage of the conveyor belt cutout under the heating means, but also the presence of the conveyor belt under the heating means between two successive drying operations, which makes it possible to prevent heat dissipation towards the transport station and the printing station when drying is not needed, even though the heating means remains on for the reasons previously mentioned in this introduction.

By proceeding in this manner, the Applicant has not only succeeded in optimizing the drying process but also in mitigating the adverse effects associated with heating, such as mechanical issues (for instance, expansion and/or aging) within the transport station or even problems of ricochet drying of the printing means (for instance, the print heads themselves). Furthermore, the Applicant believes that maintaining the heating atmosphere within the drying station when the movable opening/closing means is closed contributes to better uniformity and even drying efficiency when the movable opening/closing means reopens.

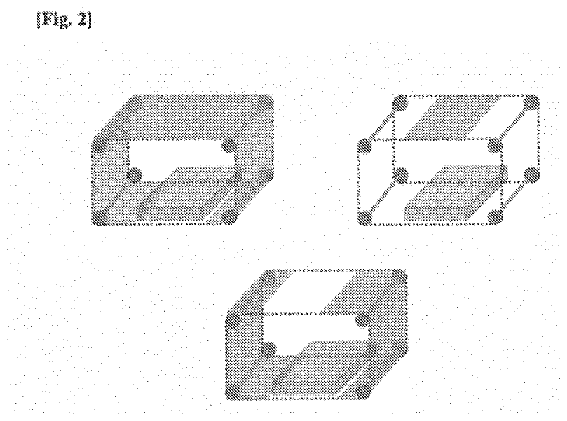

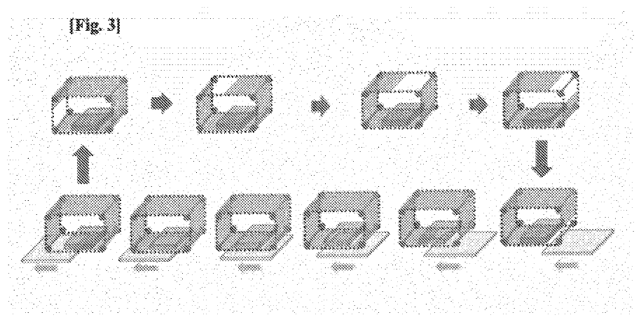

In FIGS. 1 and 3, the cutout surface of the conveyor belt corresponds to that of the infrared cassette. This is also true in the sub-figures at the top left and bottom of FIG. 2; the bottom sub-figure illustrates a conveyor belt with two identical, spaced cutouts.

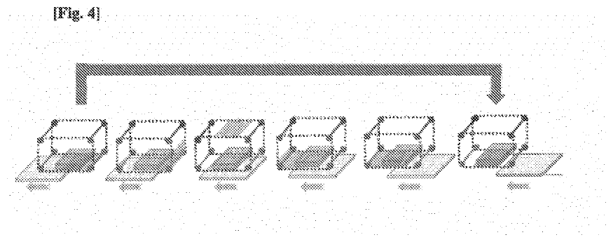

In FIG. 4, the sealing surface of the conveyor belt corresponds to that of the infrared cassette. This is also true in the sub-figures at the top right of FIG. 2.

In FIG. 3, the sealing surface may be described starting from the bottom right of the sub-diagram, which illustrates the feed of the printed substrate (which is transported from right to left) into the drying station as well as the clockwise rotation of the opening/closing conveyor belt; the edges before the cutout of the conveyor belt and the portion of substrate to be dried (in this case, in the illustration, the front edge of the substrate) coincide during their respective forward motion, allowing for the progressive opening of the surface located under the heating means. Three scenarios can then arise:
the longitudinal dimension (in the direction of transport) of the portion of substrate to be dried is less than, equal to, or greater than the longitudinal dimension of the conveyor belt's opening surface, as this factor can be advantageously taken into account by the conveyor belt drive system. Indeed, since there is a means for controlling the speed of the mobile movable opening/closing means based on the substrate transport speed that it receives from the transport station, it will only suffice to ensure that the conveyor belt speed is lower, identical to, or higher than the substrate transport speed in order that the rear edges of the conveyor belt cutout and the portion of substrate to be dried (in this case, in the illustration, the rear edge of the substrate) coincide during their respective forward motion, thereby enabling the proper progressive closure of the surface located under the heating means.

The present invention also relates to the use of the printing device and/or method according to any of the embodiments already described in an inkjet printing machine that sprays a solvent-based and/or water-based ink or varnish.

The present application describes various technical features and advantages with reference to the figures and/or various embodiments. A person skilled in the art will understand that the technical features of a given embodiment may, in fact, be combined with features of another embodiment unless the opposite is explicitly stated or it is obvious that these features are incompatible. Furthermore, the technical features described in a given embodiment may be isolated from the other features of that embodiment unless the opposite is explicitly stated.

It should be obvious to a person skilled in the art that the present invention allows for embodiments in many other specific forms without departing from the scope of the invention as claimed. Therefore, the present embodiments should be considered illustrative but may be modified within the scope defined by the appended claims, and the invention should not be limited to the details given above.

1. A substrate printing device comprising:
at least one ink/varnish printing station,
followed by a station for drying a printed substrate without contact with the printed substrate, and
a transport station for transporting the substrate through said printing and drying stations, wherein the three printing, drying, and transport stations are controlled by means of at least one control station, the drying station is a drying station that comprises infrared and/or near-infrared and/or ultraviolet (UV) drying means, a control station of the drying station, and a movable opening/closing means controlled by the control station of the drying station, wherein said movable opening/closing means is positioned between the drying means and the printed substrate.

2. The device according to claim 1, wherein the device is configured to control a power of the drying means based on a quantity of ink/varnish deposited per unit area to be dried, and/or a content and type of solvent contained in the ink/varnish, and/or a transport speed of the substrate through the drying station.

3. The device according to one of the preceding claims claim 1, wherein the movable opening/closing means is fully mobile.

4. The device according to claim 1, wherein the movable opening/closing means is a flat, flexible surface that rotates around the drying means.

5. The device according to claim 1, wherein the movable opening/closing means is a rotating conveyor belt.

6. The device according to claim 1, wherein the movable opening/closing means is a rotating conveyor belt made of one or more layers of woven or non-woven textile materials.

7. The device according to claim 1, wherein the movable opening/closing means is a rotating conveyor belt made of high-temperature textile materials having a melting point above 750° C.

8. The device according to claim 1, wherein the movable opening/closing means is a rotating conveyor belt made of textile materials having thermal conductivity values measured in W/m° C. at a temperature of 500° C. of less than 0.5.

9. The device according to any of the preceding claims claim 1, wherein the movable opening/closing means is a rotating conveyor belt having at least one cutout surface adapted to a surface of the drying means.

10. The device according to claim 1, wherein an opening/closing of the movable opening/closing means is controlled by the control station of the drying station based on information transmitted by the printing station and/or the transport station.

11. The device according to claim 10, wherein the information is a transport speed of the substrate through the drying station and/or a distance between each substrate portion and/or between each substrate to be dried.

12. The device according to claim 9, wherein the control station of the drying station controls a rotational speed of the rotating conveyor belt.

13. The device according to claim 1, wherein printing performed by the printing station is of a sheet-fed or reel-to-reel type.

14. A printing, transport, and drying method, implemented by the substrate printing device according to claim 1, comprising:
the control station of the drying station receiving instructions from the transport station and/or the printing station to control an opening of the movable opening/closing means during a passage of a useful surface of the substrate and to control a closing of the movable opening/closing means after the passage of the useful surface of the substrate, wherein the useful surface of the substrate is a printed portion of the printed substrate.

15. A method of using the device according to claim 1, comprising using the device for an inkjet printing machine that sprays a solvent-based and/or water-based ink or varnish.

16. The method according to claim 14, further comprising using the device for an inkjet printing machine that sprays a solvent-based and/or water-based ink or varnish.
